(19) United States
(12) Patent Application Publication
(10) Pub. No.: US 2024/0338211 A1
(43) Pub. Date: Oct. 10, 2024

(54) DYNAMIC SOURCE CODE ANALYSIS AND NATURAL LANGUAGE ANNOTATION

(71) Applicant: Intemational Business Machines Corporation, Armonk, NY (US)

(72) Inventors: Aaron K. Baughman, Cary, NC (US); Jeremy R. Fox, Georgetown, TX (US); Sarbajit K. Rakshit, Kolkata, IN (US); Ryan Landers, Columbus, OH (US)

(73) Assignee: Intemational Business Machines Corporation, Armonk, NY (US)

(21) Appl. No.: 18/131,649

(22) Filed: Apr. 6, 2023

(51) Int. Cl. G06F 8/73; G06F 8/75

(52) U.S. Cl. CPC G06F 8/73; G06F 8/75

(57) ABSTRACT

Each of a plurality of portions of a source code base of an application is classified into an algorithm type in a predefined set of algorithm types. A code base model of the source code base is constructed, the code base model comprising a plurality of nodes connected by edges, a node in the plurality of nodes representing a classified portion in the plurality of portions. In response to a natural language query about the source code base, a natural language explanation of the classified portion is generated.

### BACKGROUND

The present invention relates generally to a method, system, and computer program product for source code analysis. More particularly, the present invention relates to a method, system, and computer program product for dynamic source code analysis and natural language annotation.

The source code base of an application includes one or more modules implementing portions of the application's functions. Source code within the source code base is written in a programming language (e.g., C++ or Python). A compiler or interpreter converts the source code into executable code for execution on a system including a processor and memory. (Python is a registered trademark of the Python Software Foundation in the United States and other countries.) Source code typically includes comments, which are words or phrases intended to comment on or otherwise explain accompanying source code. Comments are not converted into executable code.

A natural language is a human language, such as English or French.

### SUMMARY

The illustrative embodiments provide a method, system, and computer program product. An embodiment includes a method that classifies, into an algorithm type in a predefined set of algorithm types, each of a plurality of portions of a source code base of an application. An embodiment constructs a code base model of the source code base, the code base model comprising a plurality of nodes connected by edges, a node in the plurality of nodes representing a classified portion in the plurality of portions. An embodiment generates, in response to a natural language query about the source code base, a natural language explanation of the classified portion.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for dynamic source code analysis and natural language annotation in accordance with an illustrative embodiment;

FIG. 3 depicts a flow diagram of an example configuration for dynamic source code analysis and natural language annotation in accordance with an illustrative embodiment;

FIG. 4 depicts a continued flow diagram of an example configuration for dynamic source code analysis and natural language annotation in accordance with an illustrative embodiment;

FIG. 5 depicts a continued flow diagram of an example configuration for dynamic source code analysis and natural language annotation in accordance with an illustrative embodiment;

FIG. 6 depicts a continued flow diagram of an example configuration for dynamic source code analysis and natural language annotation in accordance with an illustrative embodiment;

FIG. 7 depicts a continued flow diagram of an example configuration for dynamic source code analysis and natural language annotation in accordance with an illustrative embodiment;

FIG. 8 depicts a flowchart of an example process for dynamic source code analysis and natural language annotation in accordance with an illustrative embodiment.

### DETAILED DESCRIPTION

The illustrative embodiments recognize that, when developing applications, particularly those involving machine learning and the manipulation of large amounts of data, developers and data scientists often use different methodologies. Data scientists typically develop standardized versions of algorithms in isolated test environments, while developers focus on writing scalable and production ready code. Integrating the two groups' code often results in an application that is difficult to understand, particularly when new developers or data scientists join a project. For example, it might be difficult for a developer new to a code base of an application to understand which algorithm (of those known to data scientists) is being used in an application (e.g., to implement a machine learning module within an application), which code implements which portion of an algorithm, how data is manipulated within portions of the application, where to begin debugging a reported problem with an application, and the like. Because comments intended to explain portions of the application are typically written by developers of the code, the comments are often incomplete, difficult to understand, and written in inconsistent styles by different developers. Source code documentation, a document explaining the functions of an application or an application's components, is typically maintained separately from the source code itself and is not typically maintained as source code is changed over time. Thus, comments and other documentation, while helpful, are insufficient to help a developer understand a source code base.

The illustrative embodiments also recognize that understandability, transparency. and accuracy of an application are important parts of generating trust in a machine learning application's output. Understandability, or explainability, focuses on explaining how a model reached a particular conclusion. Transparency focuses on describing a model, including elements such as the type of model used, how the model was trained, the type of training data that was used on the model, and how the model was tested. Accuracy is a metric for evaluating models, and refers to the fraction of model outputs that are considered sufficiently correct. However, it can be difficult, particularly for a developer new to a project, to understand which portions of source code contribute, and how the portions contribute, to understandability, transparency, and accuracy of an application.

Thus, the illustrative embodiments recognize that there is a need to dynamically, as a source code base changes over time, provide analysis of the source code, in natural language and a consistent comment style, as well as respond to natural language queries regarding the source code.

The illustrative embodiments recognize that the presently available tools or solutions do not address these needs or provide adequate solutions for these needs. The illustrative embodiments used to describe the invention generally address and solve the above-described problems and other problems related to dynamic source code analysis and natural language annotation.

An embodiment can be implemented as a software application. The application implementing an embodiment can be configured as a modification of an existing source code management system, as a separate application that operates in conjunction with an existing source code management system, a standalone application, or some combination thereof.

Particularly, some illustrative embodiments provide a method that classifies, into an algorithm type in a predefined set of algorithm types, each of a plurality of portions of a source code base of an application, constructs a code base model of the source code base, and generates, in response to a natural language query about the source code base, a natural language explanation of a classified portion in the plurality of portions.

An embodiment receives a source code base of an application, divides a module or file of the source code base into a plurality of portions, and identifies an author of a portion in the plurality of portions. To begin the partitioning, an embodiment selects an initial portion of a source code file. The initial portion has a size equal to the initial portion size. One embodiment sets an initial portion size, in lines of code, by multiplying an initial portion size percentage by the number of lines of code in a particular source code file. The initial portion size percentage is based on how much code generally holds an algorithm definition, as established by using multiple regression model on historical training data such as total lines of code, number of classes, number of individual files, number of packages, number of algorithms, number of models, average lines of code per file, and the like. Another embodiment sets an initial portion size to one line of code. Other initial portion sizes are also possible and contemplated within the scope of the illustrative embodiments. One embodiment selects an initial portion of a source code file from a midpoint of a source code file. Other embodiments select an initial portion of a source code file from the beginning, end, or another location in a source code file.

An embodiment applies source code within the initial portion to two parallel processing pipelines. In one pipeline, an embodiment uses a trained code embedding model to convert a portion of source code to a corresponding code embedding. A code embedding is a multidimensional numerical representation of a portion of source code. Code embeddings represent source code syntax. A trained code embedding model is trained using other source code syntax. Code embeddings can represent any length of code. In the second pipeline, an embodiment uses a sequence-to-sequence model to convert the same input portion of source code into natural language text describing the input line of source code, and uses a trained language embedding model to convert the natural language text into a language embedding. A language embedding is a multidimensional numerical representation of a line of source code description text. A sequence-to-sequence model is a presently available technique that transforms a first sequence into a second sequence, typically using a recurrent neural network such as a long short-term memory (LSTM) or using gated recurrent units (GRUs). A sequence-to-sequence model includes an encoder network that converts each portion of an input (here, a token, word, or other portion of a line of source code) item into a corresponding numerical representation of the item and its context, followed by a decoder network that turns the numerical representation into an output item (here, a word or other portion of source code description text), using the previous output as an input context into a set of tokens. A trained language embedding model is a presently available technique that converts a sentence or other sequence of natural language words to a multidimensional numerical representation of the sentence.

An embodiment uses a trained classifier model operating on code and language embeddings representing a portion of input source code to classify the portion into one of a predefined set of code authors. The classifier model has been trained, using a presently available technique, to associate a particular combination of code and language embeddings with a particular code author. Thus, an embodiment makes a preliminary determination that, for example, Developer 1 wrote one portion of input source code, while Developer 2 wrote another portion of input source code. An embodiment forms a time sequence of code authorship determinations based on different snapshots of the input source code base. Thus, an embodiment determines that, for example, after Developer 1 wrote one portion of input source code and Developer 2 wrote another portion of input source code, Developer 3 made changes to both portions, and Developer 4 made additional changes after Developer 3.

An embodiment expands the initial portion size, reselects a portion of a source code file using the expanded portion size, and repeats the code embedding, language embedding, and authorship classification for the expanded portion of source code until reaching a completion criterion. One embodiment uses the same starting point each time. expanding the portion in both directions (i.e., earlier and later in the source code file) until the portion includes the entire source code file. Another embodiment selects different starting points, creating and processing overlapping portions of the source code file. As the portion size is expanded, an embodiment's authorship classification might change because different portions of source code might have been written by different developers. In particular, each portion, or window, of code has a code embedding and an authorship classification. Since code windows can overlap, any vote that intersects a window is included in a vote on authorship of a particular window. The author with the most votes within a singular window wins. If there is a tie, multiple authors are noted as candidates. Thus, an embodiment forms a primary sequence of code portions, along with a code portion's code and language embeddings and authorship classifications or rankings.

An embodiment re-partitions the primary sequence of code portions into a secondary partitioning of the same source code file. In particular, the primary portion, or window, is the original window while the secondary portion grows to include more context. As a result, while the primary window is the target of the partitioning, the secondary portion provides context and clues about the primary portion. In one embodiment, the secondary portioning includes overlapping portions. An embodiment forms a time sequence of secondary partitions based on different snapshots of the input source code base.

An embodiment uses a portion classification model to classify a code portion, in the primary and secondary sequences of code portions, into one of a predetermined set of algorithm types the code portion implements. Some non-limiting examples of algorithm types are predictive modeling, prescriptive optimization, descriptive statistics, and a head recursion algorithm. The portion classification model is trained before use, on labelled source code that represents specific algorithm types.

An embodiment uses the classified code portions to construct a code base model comprising nodes and edges connecting nodes. A node in the code base model represents a code portion classified into a particular algorithm type. An edge in the code base model represents a relationship between nodes representing classified code portions.

An embodiment analyzes inputs and outputs of code portions represented by nodes in the code base model to determine if an edge should connect two nodes in the model. Pieces of the nodes are linked together based on adjacencies to each other in the code or relationships of code statements. An embodiment uses a network flow optimization to determine how best to link nodes together by maximizing the flow of data between nodes. In the network flow optimization, the further nodes are from each other in terms of algorithm and vicinity, the more costly it is to put nodes together with an edge. For example, if one code portion produces an output that is consumed by a second code portion, nodes representing the two code portions might be connected by an edge. One embodiment uses trust classifiers to generate comments explaining a code portion represented by a node.

An embodiment repeats the code portioning and algorithm type classification on different snapshots in time of the input source code base, and forms or updates nodes and edges in the code base model as appropriate. Thus, the code base model stores data of the current code base, as well as how the code base has changed over time.

An embodiment uses a presently available technique, such as an LSTM-based authorship classifier model to refine or adjust a previous classification of a code portion, in the primary and secondary sequences of code portions, into one of a predefined set of code authors. In particular, the LSTM-based authorship classifier model helps to further refine who wrote what portion of the code by identifying styles and algorithmic preferences that are associated with a particular author. The authorship classification is denoted by an authorship embedding, a multidimensional numerical representation of the authorship classification. The LSTM-based authorship classifier model has been trained, using a presently available technique, to associate a particular combination of code and language embeddings with a particular code author.

An embodiment correlates a code portion classified into an algorithm type with an authorship classification of the same code portion. One embodiment adds the authorship embedding to data of the corresponding node of the code base model. Another embodiment uses a presently available natural language text generation technique, such as a feedforward neural network (FNN), to generate natural language comments indicating the authorship classification of the portion, and adds the generated comments to the portion of source code. For example, an embodiment might have determined that code portion 1 implements a classifier algorithm, and code portion 1 was written by developer 1. Thus, one embodiment might add an authorship embedding denoting “developer 1” tag to data of the code base model node representing code portion 1, while another embodiment might generate the comment “//this section written by developer 1” and add the generated comments to code portion 1 in the application source code base being analyzed.

An embodiment annotates a source code portion for one or more of transparency, accuracy, and explainability. In particular, an embodiment selects a node in the code base model and extracts, from the source code base, the source code portion or window corresponding to the selected node. An embodiment uses a trained transparency model to generate a transparency embedding representing the source code portion. A transparency embedding is a multidimensional numerical representation of a degree to which this code portion contributes to transparency in outputs of the application source code base being analyzed. An embodiment uses a trained accuracy model to generate an accuracy embedding representing the source code portion. An accuracy embedding is a multidimensional numerical representation of a degree to which this code portion contributes to accuracy in outputs of the application source code base being analyzed. An embodiment uses a trained explainability model to generate an explainability embedding representing the source code portion. An explainability embedding is a multidimensional numerical representation of a degree to which this code portion contributes to explainability in outputs of the application source code base being analyzed. The trained transparency, accuracy, and explainability models are each trained before use using labelled source code implementing transparency, accuracy, and explainability functionality respectively. An embodiment repeats the transparency, accuracy, and explainability embedding generation at different times, and the resulting data denotes how the portion's contribution to transparency, accuracy, and explainability has changed historically. An embodiment uses the historical change data and a presently available time series forecasting technique to forecast how the portion's contribution to transparency, accuracy, and explainability will change in the future. One embodiment adds generated transparency, accuracy, and explainability embeddings, and differential embeddings, to data of the node in the code base model. Another embodiment uses a presently available natural language text generation technique, such as a feedforward neural network (FNN), to generate comments indicating the portion's contribution to one or more of transparency, accuracy, and explainability, and adds the generated comments to the portion of source code.

An embodiment receives a natural language query about the source code base. An embodiment uses a presently available technique, such as an encoder/decoder model, to generate an encoded version of the query. An embodiment uses a transformer model, which transforms a structured version of a query into a graph query, to select one or more nodes and edges in the code base model that are responsive to the query. The transformer model is trained on labeled data with a question as the input and the query as the label. An embodiment uses a presently available technique such as a feature extractor to generate a structured representation of data responsive to the query. An embodiment uses a presently available technique to generate, from the structured representation, a natural language explanation of a code portion corresponding to a selected node. For example, a user might ask for code implementing a head recursion algorithm in the source code, and in response an embodiment might select a node in the code base model classified as implementing a head recursion algorithm, generate a structured representation of data of the node (e.g., where the source code portion represented by the node is located in the source code, an author of the source code portion, when the source code portion was last changed, and the like), and generate a natural language explanation: here is an example of code implementing a head recursion algorithm, the code was written by Developer 1, and last changed yesterday.

The manner of dynamic source code analysis and natural language annotation described herein is unavailable in the presently available methods in the technological field of endeavor pertaining to source code analysis and management. A method of an embodiment described herein, when implemented to execute on a device or data processing system, comprises substantial advancement of the functionality of that device or data processing system in classifying, into an algorithm type in a predefined set of algorithm types, each of a plurality of portions of a source code base of an application, constructing a code base model of the source code base, and generating, in response to a natural language query about the source code base, a natural language explanation of a classified portion in the plurality of portions.

The illustrative embodiments are described with respect to certain types of source code portions, apportionings, classifications, embeddings, models, structured representations, queries, responses, rankings, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

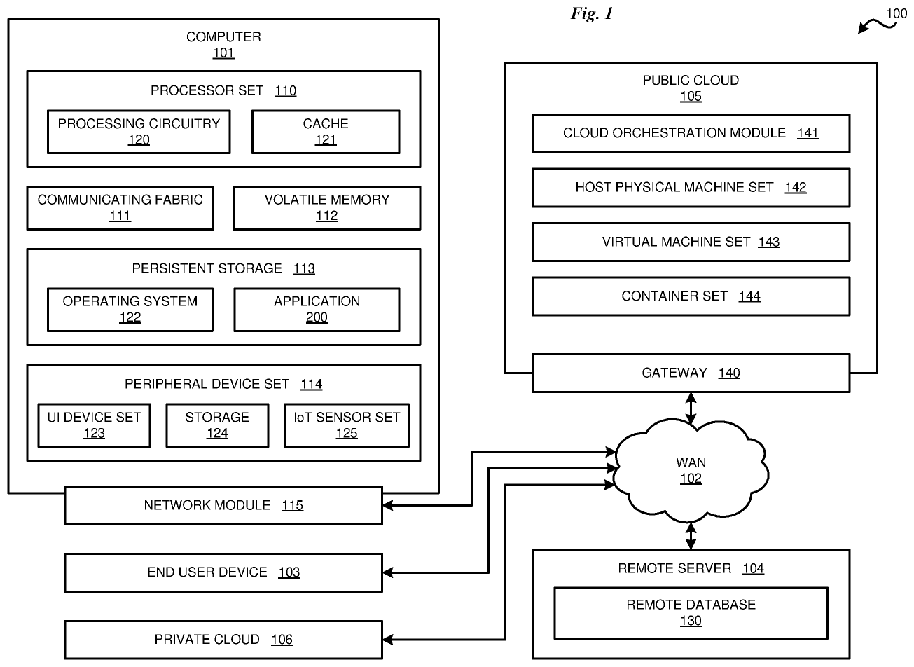

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description. FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements a dynamic source code analysis and natural language annotation embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, or a computer in public cloud 105 or private cloud 106 unless expressly disambiguated.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud. even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single-or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IoT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

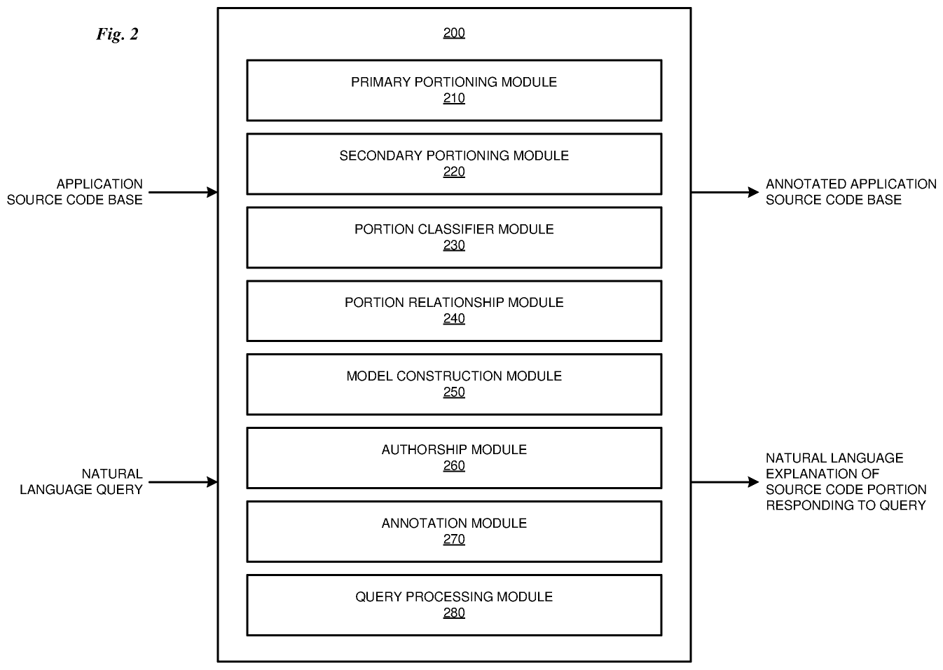

With reference to FIG. 2, this figure depicts a block diagram of an example configuration for dynamic source code analysis and natural language annotation in accordance with an illustrative embodiment. Application 200 is the same as application 200 in FIG. 1.

Primary partitioning module 210 receives a source code base of an application, divides a module or file of the source code base into a plurality of portions, and identifies an author of a portion in the plurality of portions. To begin the partitioning, module 210 selects an initial portion of a source code file. The initial portion has a size equal to the initial portion size. One implementation of module 210 sets an initial portion size, in lines of code, by multiplying an initial portion size percentage by the number of lines of code in a particular source code file. The initial portion size percentage is based on how much code generally holds an algorithm definition, as established by using multiple regression model on historical training data such as total lines of code, number of classes, number of individual files, number of packages, number of algorithms, number of models, average lines of code per file, and the like. Another implementation of module 210 sets an initial portion size to one line of code. Other initial portion sizes are also possible. One implementation of module 210 selects an initial portion of a source code file from a midpoint of a source code file. Other implementations of module 210 select an initial portion of a source code file from the beginning, end, or another location in a source code file.

Module 210 applies source code within the initial portion to two parallel processing pipelines. In one pipeline, module 210 uses a trained code embedding model to convert a portion of source code to a corresponding code embedding. A code embedding is a multidimensional numerical representation of a portion of source code. Code embeddings represent source code syntax. A trained code embedding model is trained using other source code syntax. Code embeddings can represent any length of code. In the second pipeline, module 210 uses a sequence-to-sequence model to convert the same input portion of source code into natural language text describing the input line of source code, and uses a trained language embedding model to convert the natural language text into a language embedding (a multidimensional numerical representation of a line of source code description text).

Module 210 uses a trained classifier model operating on code and language embeddings representing a portion of input source code to classify the portion into one of a predefined set of code authors. The classifier model has been trained, using a presently available technique, to associate a particular combination of code and language embeddings with a particular code author. Thus, module 210 makes a preliminary determination that, for example, Developer 1 wrote one portion of input source code, while Developer 2 wrote another portion of input source code. Module 210 forms a time sequence of code authorship determinations based on different snapshots of the input source code base. Thus, module 210 determines that, for example, after Developer 1 wrote one portion of input source code and Developer 2 wrote another portion of input source code, Developer 3 made changes to both portions, and Developer 4 made additional changes after Developer 3.

Module 210 expands the initial portion size, reselects a portion of a source code file using the expanded portion size, and repeats the code embedding, language embedding, and authorship classification for the expanded portion of source code until reaching a completion criterion. One implementation of module 210 uses the same starting point each time, expanding the portion in both directions (i.e., earlier and later in the source code file) until the portion includes the entire source code file. Another implementation of module 210 selects different starting points, creating and processing overlapping portions of the source code file. As the portion size is expanded, module 210's authorship classification might change because different portions of source code might have been written by different developers. In particular, each portion, or window, of code has a code embedding and an authorship classification. Since code windows can overlap, any vote that intersects a window is included in a vote on authorship of a particular window. The author with the most votes within a singular window wins. If there is a tie, multiple authors are noted as candidates. Thus, module 210 forms a primary sequence of code portions, along with a code portion's code and language embeddings and authorship classifications or rankings.

Secondary portioning module 220 re-partitions the primary sequence of code portions into a secondary partitioning of the same source code file. In particular, the primary portion, or window, is the original window while the secondary portion grows to include more context. As a result, while the primary window is the target of the partitioning, the secondary portion provides context and clues about the primary portion. In one implementation of module 220, the secondary portioning includes overlapping portions. Module 220 forms a time sequence of secondary partitions based on different snapshots of the input source code base.

Portion classifier module 230 uses a portion classification model to classify a code portion, in the primary and secondary sequences of code portions, into one of a predetermined set of algorithm types the code portion implements. Some non-limiting examples of algorithm types are predictive modeling, prescriptive optimization, descriptive statistics, and a head recursion algorithm. The portion classification model is trained before use, on labelled source code that represents specific algorithm types.

Model construction module 250 uses the classified code portions to construct a code base model comprising nodes and edges connecting nodes. A node in the code base model represents a code portion classified into a particular algorithm type. An edge in the code base model represents a relationship between nodes representing classified code portions.

Portion relationship module 240 analyzes inputs and outputs of code portions represented by nodes in the code base model to determine if an edge should connect two nodes in the model. Pieces of the nodes are linked together based on adjacencies to each other in the code or relationships of code statements. Module 240 uses a network flow optimization to determine how best to link nodes together by maximizing the flow of data between nodes. In the network flow optimization, the further nodes are from each other in terms of algorithm and vicinity, the more costly it is to put nodes together with an edge. For example, if one code portion produces an output that is consumed by a second code portion, nodes representing the two code portions might be connected by an edge. One implementation of module 240 uses trust classifiers to generate comments explaining a code portion represented by a node.

Modules 230, 240, and 250 repeat the code portioning and algorithm type classification on different snapshots in time of the input source code base, and form or update nodes and edges in the code base model as appropriate. Thus, the code base model stores data of the current code base, as well as how the code base has changed over time.

Authorship module 260 uses a presently available technique, such as an LSTM-based authorship classifier model to refine or adjust a previous classification of a code portion, in the primary and secondary sequences of code portions, into one of a predefined set of code authors. In particular, the LSTM-based authorship classifier model helps to further refine who wrote what portion of the code by identifying styles and algorithmic preferences that are associated with a particular author. The authorship classification is denoted by an authorship embedding, a multidimensional numerical representation of the authorship classification. The LSTM-based authorship classifier model has been trained, using a presently available technique, to associate a particular combination of code and language embeddings with a particular code author.

Module 260 correlates a code portion classified into an algorithm type with an authorship classification of the same code portion. One implementation of module 260 adds the authorship embedding to data of the corresponding node of the code base model. Another implementation of module 260 uses a presently available natural language text generation technique, such as a feedforward neural network (FNN), to generate comments indicating the authorship classification of the portion, and adds the generated comments to the portion of source code. For example, module 260 might have determined that code portion 1 implements a classifier algorithm, and code portion 1 was written by developer 1. Thus, one implementation of module 260 might add an authorship embedding denoting “developer 1” tag to data of the code base model node representing code portion 1, while another implementation of module 260 might generate the comment “//this section written by developer 1” and add the generated comments to code portion 1 in the application source code base being analyzed.

Annotation module 270 annotates a source code portion for one or more of transparency, accuracy, and explainability. In particular, module 270 selects a node in the code base model and extracts, from the source code base, the source code portion or window corresponding to the selected node. Module 270 uses a trained transparency model to generate a transparency embedding representing the source code portion. A transparency embedding is a multidimensional numerical representation of a degree to which this code portion contributes to transparency in outputs of the application source code base being analyzed. Module 270 uses a trained accuracy model to generate an accuracy embedding representing the source code portion. An accuracy embedding is a multidimensional numerical representation of a degree to which this code portion contributes to accuracy in outputs of the application source code base being analyzed. Module 270 uses a trained explainability model to generate an explainability embedding representing the source code portion. An explainability embedding is a multidimensional numerical representation of a degree to which this code portion contributes to explainability in outputs of the application source code base being analyzed. The trained transparency, accuracy, and explainability models are each trained before use using labelled source code implementing transparency, accuracy, and explainability functionality respectively. Module 270 repeats the transparency, accuracy, and explainability embedding generation at different times, and the resulting data denotes how the portion's contribution to transparency, accuracy, and explainability has changed historically. Module 270 uses the historical change data and a presently available time series forecasting technique to forecast how the portion's contribution to transparency, accuracy, and explainability will change in the future. One implementation of module 270 adds generated transparency, accuracy, and explainability embeddings, and differential embeddings, to data of the node in the code base model. Another implementation of module 270 uses a presently available natural language text generation technique, such as a feedforward neural network (FNN), to generate comments indicating the portion's contribution to one or more of transparency, accuracy, and explainability, and adds the generated comments to the portion of source code.

Query processing module 280 receives a natural language query about the source code base. Module 280 uses a presently available technique, such as an encoder/decoder model, to generate an encoded version of the query. Module 280 uses a transformer model, which transforms a structured version of a query into a graph query, to select one or more nodes and edges in the code base model that are responsive to the query. The transformer model is trained on labeled data with a question as the input and the query as the label. Module 280 uses a presently available technique such as a feature extractor to generate a structured representation of data responsive to the query. Module 280 uses a presently available technique to generate, from the structured representation, a natural language explanation of a code portion corresponding to a selected node. For example, a user might ask for code implementing a head recursion algorithm in the source code, and in response module 280 might select a node in the code base model classified as implementing a head recursion algorithm, generate a structured representation of data of the node (e.g., where the source code portion represented by the node is located in the source code, an author of the source code portion, when the source code portion was last changed, and the like), and generate a natural language explanation: here is an example of code implementing a head recursion algorithm, the code was written by Developer 1, and last changed yesterday.

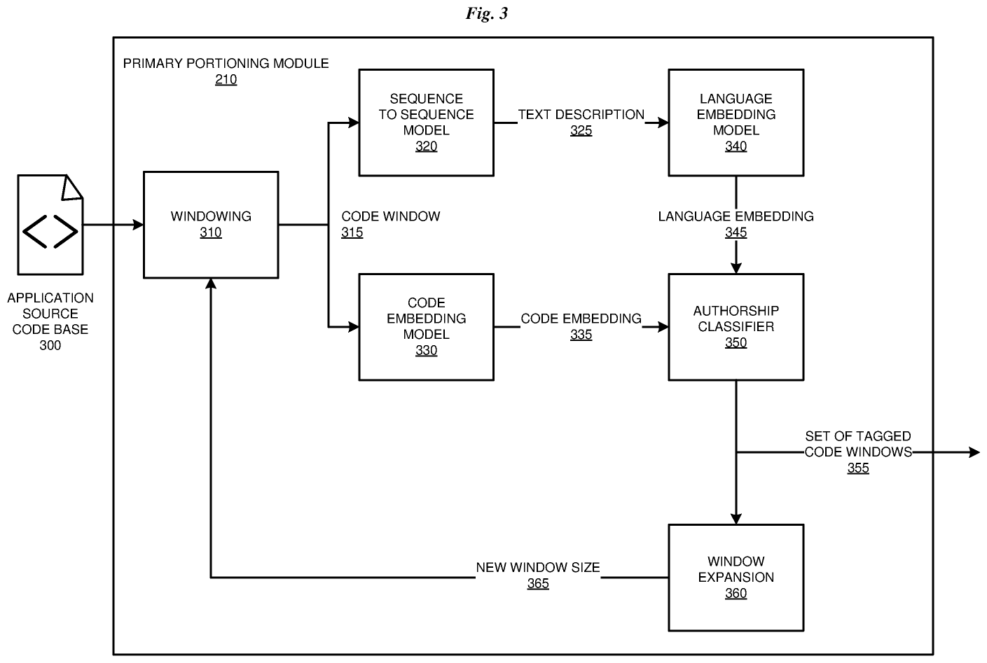

With reference to FIG. 3, this figure depicts a flow diagram of an example configuration for dynamic source code analysis and natural language annotation in accordance with an illustrative embodiment. The flow diagram can be executed using application 200 in FIG. 2. Primary partitioning module 210 is the same as primary partitioning module 210 in FIG. 2.

Primary partitioning module 210 receives application source code base 300. Windowing 310 selects an initial portion of a source code file: window 315. Window 315 is applied to two parallel processing pipelines. In one pipeline, code embedding model 330 converts a line of source code to corresponding code embedding 335, a multidimensional numerical representation of a line of source code. In the second pipeline, sequence-to-sequence model 320 converts an input line of source code into text description 325, natural language text describing the input line of source code. Language embedding model 340 converts text description 325 into language embedding 345 (a multidimensional numerical representation of a line of source code description text).

Authorship classifier 350 operates on one or more of code embedding 335 and language embedding 345 to classify code window 315 into one of a predefined set of code authors. Once additional portions of source code base 300 have been processed, the result is set of tagged code windows 355.

Window expansion 360 expands the initial portion size into new window size 365, windowing 310 reselects a portion of a source code file using new window size 365, and the code embedding, language embedding, and authorship classification for the expanded portion of source code are repeated until a completion criterion is reached.

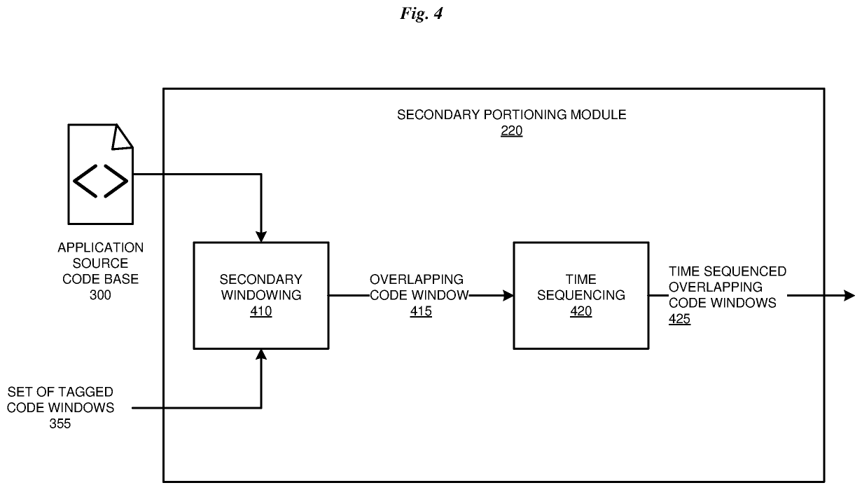

With reference to FIG. 4, this figure depicts a continued flow diagram of an example configuration for dynamic source code analysis and natural language annotation in accordance with an illustrative embodiment. Secondary partitioning module 220 is the same as secondary partitioning module 220 in FIG. 2. Application source code base 300 and set of tagged code windows 355 are the same as application source code base 300 and set of tagged code windows 355 in FIG. 3.

Secondary windowing 410 re-partitions application source code base 300 and set of tagged code windows 355 into a secondary partitioning of the same source code file: overlapping code windows 415. Time sequencing 420 forms time sequenced overlapping code windows 425 based on different snapshots of source code base 300.

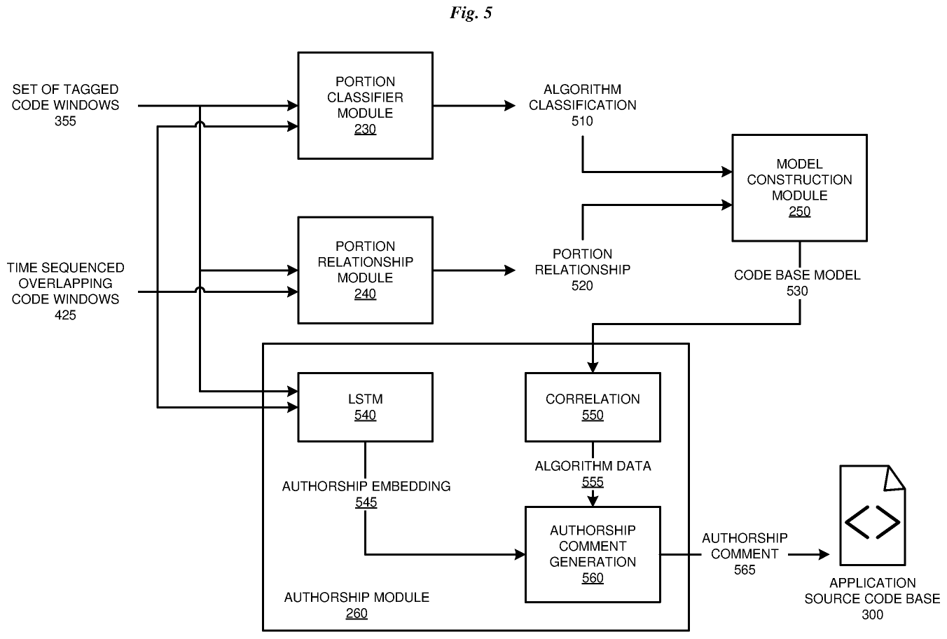

With reference to FIG. 5, this figure depicts a continued flow diagram of an example configuration for dynamic source code analysis and natural language annotation in accordance with an illustrative embodiment. Portion classifier module 230, portion relationship module 240, model construction module 250, and authorship module 260 are the same as portion classifier module 230, portion relationship module 240, model construction module 250, and authorship module 260 in FIG. 2. Application source code base 300 and set of tagged code windows 355 are the same as application source code base 300 and set of tagged code windows 355 in FIG. 3. Time sequenced overlapping code windows 425 is the same as time sequenced overlapping code windows 425 in FIG. 4.

Portion classifier module 230 uses a portion classification model to classify a code portion, in sets 355 or 425 into one of a predetermined set of algorithm types the code portion implements. The result is algorithm classification 510. Portion relationship module 240 analyzes inputs and outputs of code portions in sets 355 or 425 and represented by nodes in the code base model to determine portion relationship 520, denoting whether an edge should connect two nodes in the model. Model construction module 250 uses algorithm classification 510 and portion relationship 520 to construct code base model 530 comprising nodes and edges connecting nodes.

Authorship module 260 uses LSTM 540 to refine or adjust a previous classification of a code portion in sets 355 and 425 into one of a predefined set of code authors. The authorship classification is denoted by authorship embedding 545, a multidimensional numerical representation of the authorship classification. Correlation 550 correlates a code portion classified into an algorithm type (in code base model 530) with authorship embedding 545 of the same code portion, generating algorithm data 555 (data of the correlated code portion). Authorship comment generation 560 generates authorship comment 565, comments indicating the authorship classification of the portion, and adds comment 565 the portion of source code in code base 300.

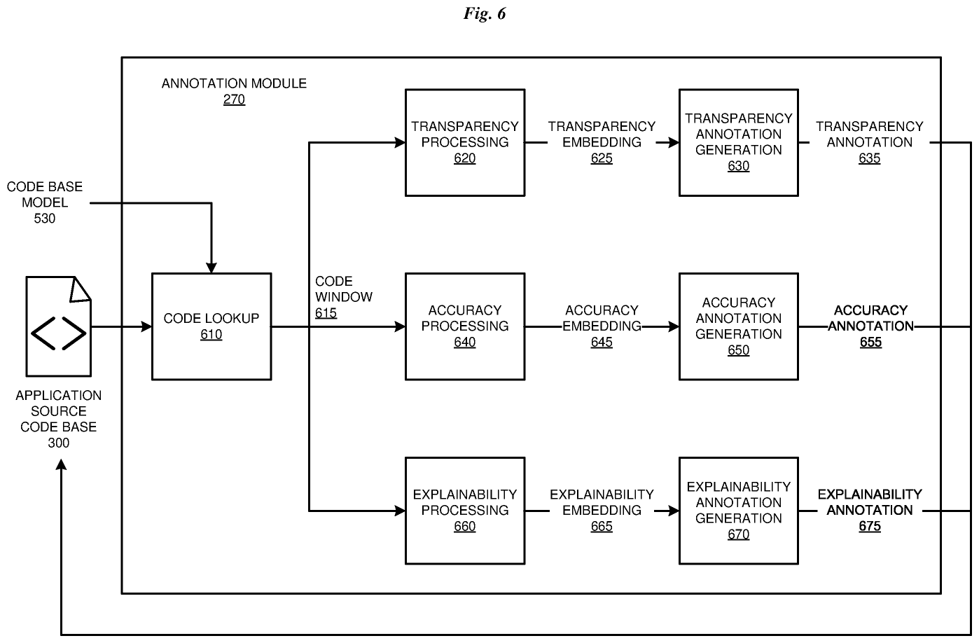

With reference to FIG. 6, this figure depicts a continued flow diagram of an example configuration for dynamic source code analysis and natural language annotation in accordance with an illustrative embodiment. Annotation module 270 is the same as annotation module 270 in FIG. 2. Application source code base 300 is the same as application source code base 300 in FIG. 3. Code base model 530 is the same as Code base model 530 in FIG. 5.

Code lookup 610 selects a node in code base model 530 and extracts, from source code base 300, code window 615: the source code portion or window corresponding to the selected node. Transparency processing 620 generate transparency embedding 625 representing code window 615. Accuracy processing 640 generate accuracy embedding 645 representing code window 615. Explainability processing 660 generate explainability embedding 665 representing code window 615. Transparency annotation generation 630 generates transparency annotation 635: comments indicating code window 615′s contribution to transparency. Similarly, accuracy annotation generation 650 generates accuracy annotation 655 and explainability annotation generation 670 generates explainability annotation 675. Annotations 635, 655, and 675 are added to application source code base 300.

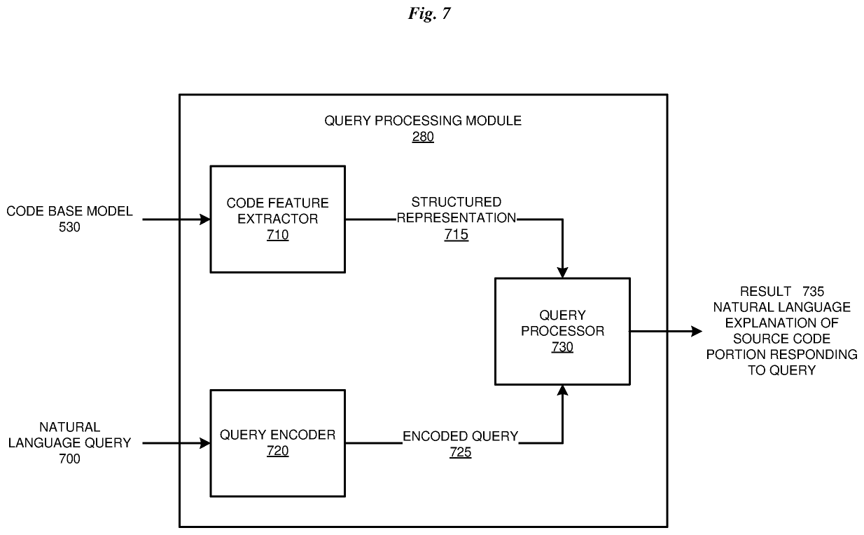

With reference to FIG. 7, this figure depicts a continued flow diagram of an example configuration for dynamic source code analysis and natural language annotation in accordance with an illustrative embodiment. Query processing module 280 is the same as query processing module in FIG. 2. Code base model 530 is the same as Code base model 530 in FIG. 5.

Query encoder 720 generates encoded query 725, an encoded version of natural language query 700 (a natural language query about the source code base). Query processor 730 selects one or more nodes and edges in the code base model that are responsive to query 700, and code feature extractor 710 generates structured representation 715: a structured representation of data responsive to query 700. Query processor 730 uses structured representation 715 to generate result 735: a natural language explanation of a code portion responding to query 700.

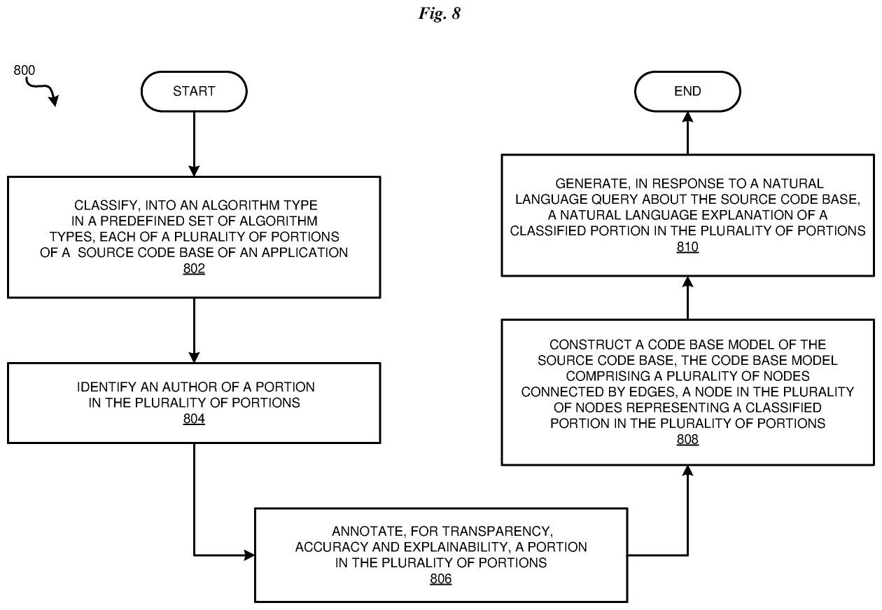

With reference to FIG. 8, this figure depicts a flowchart of an example process for dynamic source code analysis and natural language annotation in accordance with an illustrative embodiment. Process 800 can be implemented in application 200 in FIG. 2.

In block 802, the application classifies, into an algorithm type in a predefined set of algorithm types, each of a plurality of portions of a source code base of an application. In block 804, the application identifies an author of a portion in the plurality of portions. In block 806, the application annotates, for transparency, accuracy, and explainability, a portion in the plurality of portions. In block 808, the application constructs a code base model of the source code base, the code base model comprising a plurality of nodes connected by edges, a node in the plurality of nodes representing a classified portion in the plurality of portions. In block 810, the application generates, in response to a natural language query about the source code base, a natural language explanation of a classified portion in the plurality of portions. Then the application ends.

Thus, a computer implemented method, system or apparatus, and computer program product are provided in the illustrative embodiments for dynamic source code analysis and natural language annotation and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

What is claimed is:

1. A computer-implemented method comprising:
classifying, into an algorithm type in a predefined set of algorithm types, each of a plurality of portions of a source code base of an application;
constructing a code base model of the source code base, the code base model comprising a plurality of nodes connected by edges, a node in the plurality of nodes representing a classified portion in the plurality of portions; and
generating, in response to a natural language query about the source code base, a natural language explanation of the classified portion.

2. The computer-implemented method of claim 1, further comprising:
identifying, using a trained authorship classification model, an author of the classified portion, the author represented by an authorship embedding;
generating, from the authorship embedding using a feedforward neural network, a natural language authorship comment indicating the author of the classified portion; and
inserting, into the classified portion, the natural language authorship comment.

3. The computer-implemented method of claim 2, wherein the natural language explanation includes an authorship explanation derived from the natural language authorship comment.

4. The computer-implemented method of claim 1, further comprising:
identifying, using a trained transparency model, a transparency contribution of the classified portion in an output of the application, the transparency contribution represented by a transparency embedding;
generating, from the transparency embedding using a feedforward neural network, a natural language transparency comment indicating the transparency contribution; and
inserting, into the classified portion, the natural language transparency comment.

5. The computer-implemented method of claim 4, wherein the natural language explanation includes a transparency explanation derived from the natural language transparency comment.

6. The computer-implemented method of claim 1, further comprising:
identifying, using a trained accuracy model, an accuracy contribution of the classified portion in an output of the application, the accuracy contribution represented by an accuracy embedding;
generating, from the accuracy embedding using a feedforward neural network, a natural language accuracy comment indicating the accuracy contribution; and
inserting, into the classified portion, the natural language accuracy comment.

7. The computer-implemented method of claim 6, wherein the natural language explanation includes an accuracy explanation derived from the natural language accuracy comment.

8. The computer-implemented method of claim 1, further comprising:
identifying, using a trained explainability model, an explainability contribution of the classified portion in an output of the application, the explainability contribution represented by an explainability embedding;
generating, from the explainability embedding using a feedforward neural network, a natural language explainability comment indicating the explainability contribution; and
inserting, into the classified portion, the natural language explainability comment.

9. The computer-implemented method of claim 8, wherein the natural language explanation includes an explainability explanation derived from the natural language explainability comment.

10. The computer-implemented method of claim 1, wherein generating the natural language explanation of the classified portion comprises:
generating, using an encoder/decoder model, an encoded version of the natural language query;
generating, using a feature extractor, a structured representation of source code of the classified portion; and
generating, from the structured representation, the natural language explanation.

11. A computer program product comprising one or more computer readable storage medium, and program instructions collectively stored on the one or more computer readable storage medium, the program instructions executable by a processor to cause the processor to perform operations comprising:
classifying, into an algorithm type in a predefined set of algorithm types, each of a plurality of portions of a source code base of an application;
constructing a code base model of the source code base, the code base model comprising a plurality of nodes connected by edges, a node in the plurality of nodes representing a classified portion in the plurality of portions; and
generating, in response to a natural language query about the source code base, a natural language explanation of the classified portion.

12. The computer program product of claim 11, wherein the stored program instructions are stored in a computer readable storage device in a data processing system, and wherein the stored program instructions are transferred over a network from a remote data processing system.

13. The computer program product of claim 11, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

14. The computer program product of claim 11, further comprising:
identifying, using a trained authorship classification model, an author of the classified portion, the author represented by an authorship embedding;
generating, from the authorship embedding using a feedforward neural network, a natural language authorship comment indicating the author of the classified portion; and
inserting, into the classified portion, the natural language authorship comment.

15. The computer program product of claim 14, wherein the natural language explanation includes an authorship explanation derived from the natural language authorship comment.

16. The computer program product of claim 11, further comprising:
identifying, using a trained transparency model, a transparency contribution of the classified portion in an output of the application, the transparency contribution represented by a transparency embedding;
generating, from the transparency embedding using a feedforward neural network, a natural language transparency comment indicating the transparency contribution; and
inserting, into the classified portion, the natural language transparency comment.

17. The computer program product of claim 16, wherein the natural language explanation includes a transparency explanation derived from the natural language transparency comment.

18. The computer program product of claim 11, further comprising:
identifying, using a trained accuracy model, an accuracy contribution of the classified portion in an output of the application, the accuracy contribution represented by an accuracy embedding;
generating, from the accuracy embedding using a feedforward neural network, a natural language accuracy comment indicating the accuracy contribution; and
inserting, into the classified portion, the natural language accuracy comment.

19. The computer program product of claim 18, wherein the natural language explanation includes an accuracy explanation derived from the natural language accuracy comment.

20. A computer system comprising a processor and one or more computer readable storage media, and program instructions collectively stored on the one or more computer readable storage media, the program instructions executable by the processor to cause the processor to perform operations comprising:
classifying, into an algorithm type in a predefined set of algorithm types, each of a plurality of portions of a source code base of an application;
constructing a code base model of the source code base, the code base model comprising a plurality of nodes connected by edges, a node in the plurality of nodes representing a classified portion in the plurality of portions; and
generating, in response to a natural language query about the source code base, a natural language explanation of the classified portion.
